(19) United States
(12) Patent Application Publication
(10) Pub. No.: US 2009/0146844 A1
(43) Pub. Date: Jun. 11, 2009

(54) SpeedSense, an Intelligent Electronic Top Speed Control Automotive Safety Device

(76) Inventor: Reza Mohamed Hassan, Clifton, VA (US)

Correspondence Address: REZA M. HASSAN, 13807 FOGGY HILLS COURT, CLIFTON, VA, 20124, US

(21) Appl. No.: 11/952,612

(22) Filed: Dec. 7, 2007

(51) Int. Cl. G08G 1/01

(52) U.S. Cl. 340/936

(57) ABSTRACT

An electronic automotive speed control safety device, which limits the maximum speed (Top Speed) allowed of any vehicle, in real time, based on the road it is traveling on. Combining the current GPS navigation technology and the electronic speed limiter technology, this device monitors and controls the maximum speed allowed of the vehicle for particular road it is travelling on. This device recognize the location of the vehicle, current speed, posted speed limit, and limits the maximum speed of the vehicle for that location. The maximum speed limit allowed is programmed by software setting during the time of installation. For example, if you want to allow your 16 year old child to be able to drive up to 30 MPH on the 25 MPH Zone, you can program the OVER_SPEED_LIMIT (OSL) parameter to +5.

An intelligent Automotive Safety Device, which controls and adjust the maximum speed (Top Speed) allowed of any vehicle, in real time, based on the posted speed limit. The device will monitor the actual speed of the vehicle, and limit the maximum speed of the vehicle based on the posted speed limit for the road the vehicle is travelling on. The maximum speed limit allowed over the speed limit can be programmed during the time of installation. (For example, if you want to allow your 16 year old child to be able to drive up to 30 MPH on the 25 MPH Zone, you can program the OVER_SPEED_LIMIT (OSL) parameter to +5 MPH using simple process at the time of installation.)

1. Intelligent Electronic Automotive Safety Device, which controls and adjust the maximum speed (Top Speed), allowed of any vehicle, in real time, based on the posted speed limit, using available GPS Technology, Electronic Speed Limiter on the Vehicle ECU and custom software application.

2. The concept of combining available GPS Technology, an Electronic Speed Limiter technology, and a custom software application to create a single device, an Intelligent Electronic Speed Control Automotive Safety Device.
